(19) United States
(12) Patent Application Publication
(10) Pub. No.: US 2022/0063060 A1
(43) Pub. Date: Mar. 3, 2022

(54) METHOD FOR DEPOSITING ABRASIVE PARTICLES

(71) Applicant: 3M INNOVATIVE PROPERTIES COMPANY, St. Paul, MN (US)

(72) Inventors: Aaron K. Nienaber, Lake Elmo, MN (US); Richard M. Jendrejack, Hudson, WI (US); Joseph B. Eckel, Vadnais Heights, MN (US)

(21) Appl. No.: 17/415,488

(22) PCT Filed: Dec. 17, 2019
(86) PCT No.: PCT/IB2019/060924

§ 371 Date: Jun. 17, 2021

Related U.S. Application Data
(60) Provisional application No. 62/781,082, filed on Dec. 18, 2018.

(51) Int. Cl. B24D 11/00; B24D 3/00; C09K 3/14

(52) U.S. Cl. CPC B24D 11/005; C09K 3/1409; B24D 3/004

(57) ABSTRACT

The disclosure relates to, among other things, a method of making a coated abrasive article, the method comprising sequentially: locating a plurality of shaped abrasive particles in a tool comprising a plurality of cavities, wherein the plurality of shaped abrasive particles is held in the plurality of cavities, at least in part, electrostatically; and disposing the plurality of shaped abrasive particles onto a make layer precursor of a backing having first and second opposed major surfaces, wherein the make layer precursor is disposed on at least a portion of the first major surface.

### BACKGROUND

Methods are known for the delivery of abrasive articles that rely on a perforated tooling, where the abrasive particles are held in the tooling by drawing a vacuum through the perforations.

This allows the particles to remain in pockets in the tooling during subsequent steps, such as brushing and blowing the surface of the tooling to remove unwanted, loose abrasive particles. The vacuum is also used to keep the particles in the tooling pockets, while the tooling is inverted for alignment with a resin coated backing onto which the abrasive particles are deposited. But these known methods can be costly, at least because the perforated tooling can be costly to produce, operate, and/or maintain.

### SUMMARY

The methods described herein generally relate to using electrostatic forces to “pin” and hold abrasive particles into a tooling for further processing at a later step. Electrostatic forces keep the abrasive particles locked in place, even when the tooling is inverted, until the particles can be oriented properly over a backing or substrate. The methods described herein also allow for removal of loose abrasive particles from the surface of the tooling via air streams or brushes, without removing the particles from the tooling pockets. Finally, the methods described herein are versatile, as they open up more ways to pattern particles onto an abrasive web.

### DESCRIPTION OF THE FIGURES

The drawings illustrate generally, by way of example, but not by way of limitation, various embodiments discussed in the present document.

FIG. 1 is a schematic of an article maker according to the instant disclosure.

FIG. 2 is a perspective of production tool(ing) 200 that can be used in the article maker depicted in FIG. 1.

FIGS. 3A-3E are schematic diagrams of shaped abrasive particles having a tetrahedral shape, in accordance with various embodiments.

FIG. 4 are sectional views of coated abrasive articles, in accordance with various embodiments.

It should be understood that numerous other modifications and examples can be devised by those skilled in the art, which fall within the scope and spirit of the principles of the disclosure. Figures may not be drawn to scale.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “top”, “bottom”, “upper”, “lower”, “under”, “over”, “front”, “back”, “up” and “down”, and “first” and “second” may be used in this disclosure, it should be understood that those terms are used in their relative sense only unless otherwise noted.

### DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

The disclosure generally relates to a method of making a coated abrasive article, the method comprising sequentially:

locating a plurality of shaped abrasive particles in a tool comprising a plurality of cavities, wherein the plurality of shaped abrasive particles is held in the plurality of cavities electrostatically; and

disposing the plurality of shaped abrasive particles onto a make layer precursor of a backing having first and second opposed major surfaces, wherein the make layer precursor is disposed on at least a portion of the first major surface.

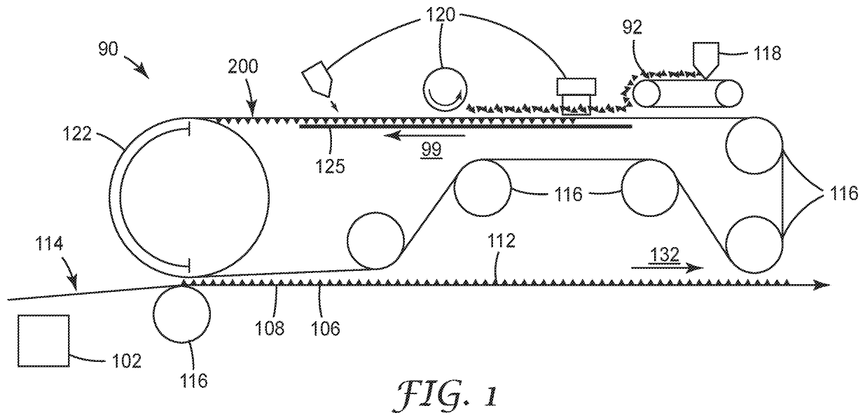

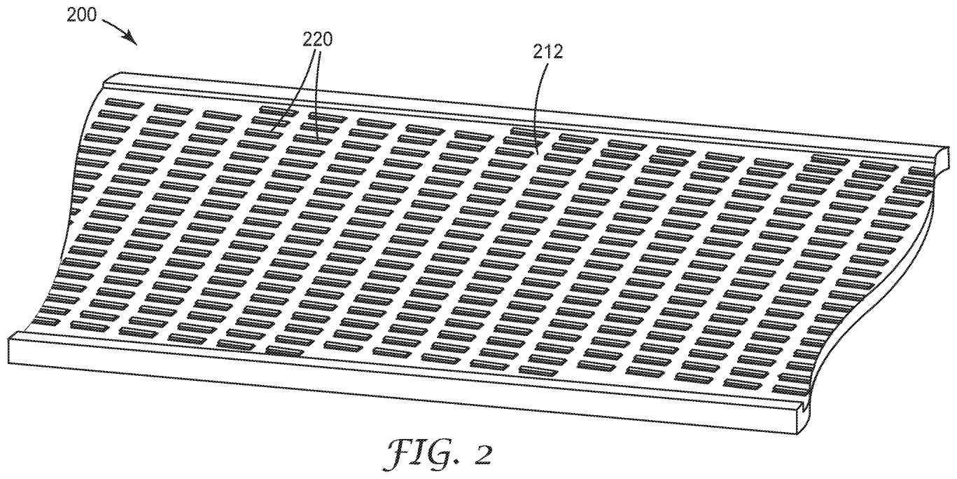

Referring now to FIG. 1, and FIG. 2, coated abrasive article maker 90 according to the present disclosure includes shaped abrasive particles 92 removably disposed within cavities 220 of production tool 200, which is interchangeably called “production tooling 200” herein, having first web path 99 guiding production tool 200 through coated abrasive article maker 90 such that it wraps a portion of an outer circumference of shaped abrasive particle transfer roll 122. Apparatus 90 can include, for example, idler rollers 116 and make coat delivery system 102. Further details on maker 90 and suitable alternative may be found at US 2016/0311081, to 3M Company, St. Paul Minn., the contents of which are hereby incorporated by reference.

These components unwind backing 106, deliver make coat resin 108 via make coat delivery system 102 to a make coat applicator and apply make coat resin to first major surface 112 of backing 106. Thereafter resin coated backing 114 is positioned by idler roll 116 for application of shaped abrasive particles 92 to first major surface 112 coated with make coat resin 108. Second web path 132 for resin coated backing 114 passes through coated abrasive article maker apparatus 90 such that resin layer positioned facing the dispensing surface 212 of production tool 200 that is positioned between resin coated backing 114 and the outer circumference of the shaped abrasive particle transfer roll 122. Suitable unwinds, make coat delivery systems, make coat resins, coaters and backings are known to those of skill in the art. Make coat delivery system 102 can be a simple pan or reservoir containing the make coat resin or a pumping system with a storage tank and delivery plumbing to translate make coat resin 108 to the needed location. Backing 106 can be a cloth, paper, film, nonwoven, scrim, or other web substrate. Make coat applicator 104 can be, for example, a coater, a roll coater, a spray system, a die coater, or a rod coater. Alternatively, a pre-coated coated backing can be positioned by idler roll 116 for application of shaped abrasive particles 92 to the first major surface.

As shown in FIG. 2, production tool 200 comprises a plurality of cavities 220 having a complimentary shape to intended shaped abrasive particle 92 to be contained therein. Shaped abrasive particle feeder 118 supplies at least some shaped abrasive particles 92 to production tool 200. Shaped abrasive particle feeder 118 can supply an excess of shaped abrasive particles 92 such that there are more shaped abrasive particles 92 present per unit length of production tool in the machine direction than cavities 220 present. Supplying an excess of shaped abrasive particles 92 helps to ensure that a desired amount of cavities 220 within the production tool 200 are eventually filled with shaped abrasive particle 92. Since the bearing area and spacing of shaped abrasive particles 92 is often designed into production tooling 200 for the specific grinding application it is desirable to not have too many unfilled cavities 220. Shaped abrasive particle feeder 118 can be the same width as the production tool 200 and can supply shaped abrasive particles 92 across the entire width of production tool 200. Shaped abrasive particle feeder 118 can be, for example, a vibratory feeder, a hopper, a chute, a silo, a drop coater, or a screw feeder. Optionally, filling assist member 120 is provided after shaped abrasive particle feeder 118 to move shaped abrasive particles 92 around on the surface of production tool 200 and to help orientate or slide shaped abrasive particles 92 into the cavities 220. Filling assist member 120 can be, for example, a doctor blade, a felt wiper, a brush having a plurality of bristles, a vibration system, a blower or air knife, a vacuum box, or combinations thereof. Filling assist member 120 moves, translates, sucks, or agitates shaped abrasive particles 92 on dispensing surface 212 (top or upper surface of production tool 200 in FIG. 1) to place more shaped abrasive particles 92 into cavities 220. Without filling assist member 120, generally at least some of shaped abrasive particles 92 dropped onto dispensing surface 212 will fall directly into cavity 220 and no further movement is required but others may need some additional movement to be directed into cavity 220. Optionally, filling assist member 120 can be oscillated laterally in the cross machine direction or otherwise have a relative motion such as circular or oval to the surface of production tool 200 using a suitable drive to assist in completely filling each cavity 220 in production tool 200 with a shaped abrasive particle 92. If a brush is used as the filling assist member 120, the bristles may cover a section of dispensing surface 212 from 2-60 inches (5.0-153 cm) in length in the machine direction across all or most all of the width of dispensing surface 212, and lightly rest on or just above dispensing surface 212 and be of a moderate flexibility. Vacuum box, if used as filling assist member 120, can be in conjunction with production tool 200 having cavities 220 extending completely through production tool 200. Vacuum box is located near shaped abrasive particle feeder 118 and may be located before or after shaped abrasive particle feeder 118 or encompass any portion of a web span between a pair of idler rolls 116 in the shaped abrasive particle filling and excess removal section of the apparatus. Alternatively, production tool 200 can be supported or pushed on by a shoe or a plate to assist in keeping it planar in this section of the apparatus instead or in addition to vacuum box 125. As shown in FIG. 1, it is possible to include one or more assist members 120 to remove excess shaped abrasive particles 92, in some embodiments it may be possible to include only one assist member 120. After leaving the shaped abrasive particle filling and excess removal section of apparatus 90 generally illustrated at 140, shaped abrasive particles 92 in production tool 200 travel towards resin coated backing 114. Shaped abrasive particle transfer roll 122 is provided and production tooling 200 can wrap at least a portion of the roll's circumference. In some embodiments, production tool 200 wraps between 30 to 180 degrees, or between 90 to 180 degrees of the outer circumference of shaped abrasive particle transfer roll 122. In some embodiments, the speed of the dispensing surface 212 and the speed of the resin layer of resin coated backing 114 are speed matched to each other within ±10 percent, ±5 percent, or ±1 percent, for example.

Various methods can be employed to transfer shaped abrasive particles 92 from cavities 220 of production tool 200 to resin coated backing 114. For the sake of completeness, one method includes a pressure assist method where each cavity 220 in production tooling 200 has two open ends or the back surface or the entire production tooling 200 is suitably porous and shaped abrasive particle transfer roll 122 has a plurality of apertures and an internal pressurized source of air. With pressure assist, production tooling 200 does not need to be inverted but it still may be inverted. Shaped abrasive particle transfer roll 122 can also have movable internal dividers such that the pressurized air can be supplied to a specific arc segment or circumference of the roll to blow shaped abrasive particles 92 out of the cavities and onto resin coated backing 114 at a specific location.

Another method, shaped abrasive particle transfer roll 122 can also be provided with an internal source of vacuum without a corresponding pressurized region or in combination with the pressurized region typically prior to the pressurized region as shaped abrasive particle transfer roll 122 rotates. The vacuum source or region can have movable dividers to direct it to a specific region or arc segment of shaped abrasive particle transfer roll 122. The vacuum can suck shaped abrasive particles 92 firmly into cavities 220 as the production tooling 200 wraps shaped abrasive particle transfer roll 122 before subjecting shaped abrasive particles 92 to the pressurized region of shaped abrasive particle transfer roll 122. This vacuum region can be used, for example, with shaped abrasive particle removal member to remove excess shaped abrasive particles 92 from dispensing surface 212 or may be used to simply ensure shaped abrasive particles 92 do not leave cavities 220 before reaching a specific position along the outer circumference of the shaped abrasive particle transfer roll 122.

Though the method described herein are directed to locating a plurality of shaped abrasive particles in a tool, such as production tool 200, comprising a plurality of cavities 220, wherein the plurality of shaped abrasive particles 92 is held in the plurality of cavities 220 electrostatically, the methods do not exclude the possibility of using at least one of vacuum or pressurized sources of air to assist either holding the particles 92 in the plurality of cavities 220. In addition, the methods described herein do not exclude the possibility of using at least pressurized sources of air to assist in disposing the plurality of shaped abrasive particles 92 onto resin coated backing 114 (e.g., a make layer precursor of a backing) having first and second opposed major surfaces, wherein the resin is disposed on at least a portion of the first major surface.

In other words, for example, even though the disposing the plurality of shaped abrasive particles 92 onto resin coated backing 114 (e.g., a make layer precursor of a backing) can be performed by, e.g., applying a voltage drop (e.g., a voltage drop of at least about 9 kV, at least 12 kV, at least 15 kV; a voltage drop from about 6 kV to about 15 kV, about 7 kV to about 12 kV or about 7 kV to 10 kV), the methods described herein do not exclude the possibility of using pressurized sources of air on abrasive particle roll 122 to assist the disposing, in addition to the voltage drop. In some examples, however, the disposing does not occur until a voltage drop is applied to the tool 200.

In keeping with the electrostatic methods described herein, the production tool 200 can be at least partially conductive (e.g., having a conductivity of 10⁻¹¹ S/m or greater) and has a front and back face, wherein the front face comprises the plurality of cavities 220. The back face of production tool 200 can be in close proximity (e.g., less than about 10 mm, less than about 5 cm, less than about 2 mm or within about 1 mm) to an electrically grounded member (e.g., shaped abrasive particle transfer roll 122), though the back face (or at least a portion thereof) of production tool 200 can be electrically grounded instead of or in addition to having an electrically grounded member, such as shaped abrasive particle transfer roll 122. The shaped abrasive particles 92 can be released from the tool and disposed onto resin coated backing 114 (e.g., a make layer precursor of a backing) by placing an inverted tool over the resin coated backing 114, which can be electrically insulated, separated by a gap from the electrically grounded member (e.g., shaped abrasive particle transfer roll 122) and applying a negative high voltage drop across the gap to release the particles 92 from the tool 200. The gap can be, for example, half the height of the shaped abrasive particles.

The plurality of shaped abrasive particles 92 can be negatively charged, in which case the tool 200 is positively charged. But the plurality of shaped abrasive particles 92 can be positively charged, in which case the tool 200 is negatively charged. The shaped abrasive particles 92 can be negatively or positively charged by exposing the shaped abrasive particles 92 to a suitable charging device (not shown). The charging device can be any suitable type for corona charging, proximity charging, injection charging, or the like. The charging device can be placed, for example, near vacuum box 125, in close proximity to the back face of production tool 200 (e.g., at a distance of less than 5 mm).

Once the shaped abrasive particles 92 are disposed onto resin coated backing 114 (e.g., a make layer precursor of a backing), the resin coated backing 114 can be at least partially cured. If the resin coated backing 114 is a make layer, the curing provides a make layer. The methods described herein then include, disposing a size layer precursor (not shown in

FIGS. 1 and 2) over at least a portion of the make layer comprising the shaped abrasive particles 92; and at least partially curing the size layer precursor layer to provide a size layer. A supersize layer (not shown in FIGS. 1 and 2) can be applied over at least a portion of the size layer.

After separating from shaped abrasive particle transfer roll 122, production tooling 200 travels along first web path 99 back towards the shaped abrasive particle filling and excess removal section of the apparatus with the assistance of idler rolls 116 as necessary. An optional production tool cleaner can be provided to remove stuck shaped abrasive particles still residing in cavities 220 and/or to remove make coat resin 108 transferred to dispensing surface 212. Choice of the production tool cleaner can depend on the configuration of the production tooling and could be either alone or in combination, an additional air blast, solvent or water spray, solvent or water bath, an ultrasonic horn, or an idler roll the production tooling wraps to use push assist to force shaped abrasive particles 92 out of the cavities 220. Thereafter endless production tooling 220 or belt advances to a shaped abrasive particle filling and excess removal section to be filled with new shaped abrasive particles 92.

Various idler rolls 116 can be used to guide the shaped abrasive particle coated backing 114 having a predetermined, reproducible, non-random pattern of shaped abrasive particles 92 on the first major surface that were applied by shaped abrasive particle transfer roll 122 and held onto the first major surface by the make coat resin along second web path 132 into an oven for curing the make coat resin. Optionally, a second shaped abrasive particle coater can be provided to place additional abrasive particles, such as another type of abrasive particle or diluents, onto the make coat resin prior to entry in an oven. The second abrasive particle coater can be a drop coater, spray coater, or an electrostatic coater as known to those of skill in the art. Thereafter a cured backing with shaped abrasive particles 92 can enter into an optional festoon along second web path 132 prior to further processing such as the addition of a size coat, curing of the size coat, and other processing steps known to those of skill in the art of making coated abrasive articles. A wide variety of abrasive particles, in addition to the shaped abrasive particles described herein, can be utilized in the methods described herein. The abrasive particles can be provided in a variety of sizes (e.g., shaped abrasive particles having at least one of an average maximum particle dimension of less than or equal to of 25 to 3000 microns and an average aspect ratio of at least 2:1), conductivity profiles (e.g., conductive or non-conductive/insulating), shapes and profiles, including, for example, random or crushed shapes, regular (e.g. symmetric) profiles such as square, star-shaped or hexagonal profiles, and irregular (e.g. asymmetric) profiles. For example, the abrasive particles can be a mixture of different types of abrasive particles. For example, the abrasive article may include mixtures of platey and non-platey particles, crushed and shaped particles (conventional non-shaped and non-platey abrasive particles (e.g. filler material) and abrasive particles of different sizes.

As used herein “shaped particle” and “shaped abrasive particle” means an abrasive particle having a predetermined or non-random shape. One process to make a shaped abrasive particle such as a shaped ceramic abrasive particle includes shaping the precursor ceramic abrasive particle in a mold having a predetermined shape to make ceramic shaped abrasive particles. Ceramic shaped abrasive particles, formed in a mold, are one species in the genus of shaped ceramic abrasive particles. Other processes to make other species of shaped ceramic abrasive particles include extruding the precursor ceramic abrasive particle through an orifice having a predetermined shape, printing the precursor ceramic abrasive particle though an opening in a printing screen having a predetermined shape, or embossing the precursor ceramic abrasive particle into a predetermined shape or pattern. In other examples, the shaped ceramic abrasive particles can be cut from a sheet into individual particles. Examples of suitable cutting methods include mechanical cutting, laser cutting, or water-jet cutting. Non-limiting examples of shaped ceramic abrasive particles include shaped abrasive particles, such as triangular plates, or elongated ceramic rods/filaments. Shaped ceramic abrasive particles are generally homogenous or substantially uniform and maintain their sintered shape without the use of a binder such as an organic or inorganic binder that bonds smaller abrasive particles into an agglomerated structure and excludes abrasive particles obtained by a crushing or comminution process that produces abrasive particles of random size and shape. In many embodiments, the shaped ceramic abrasive particles comprise a homogeneous structure of sintered alpha alumina or consist essentially of sintered alpha alumina.

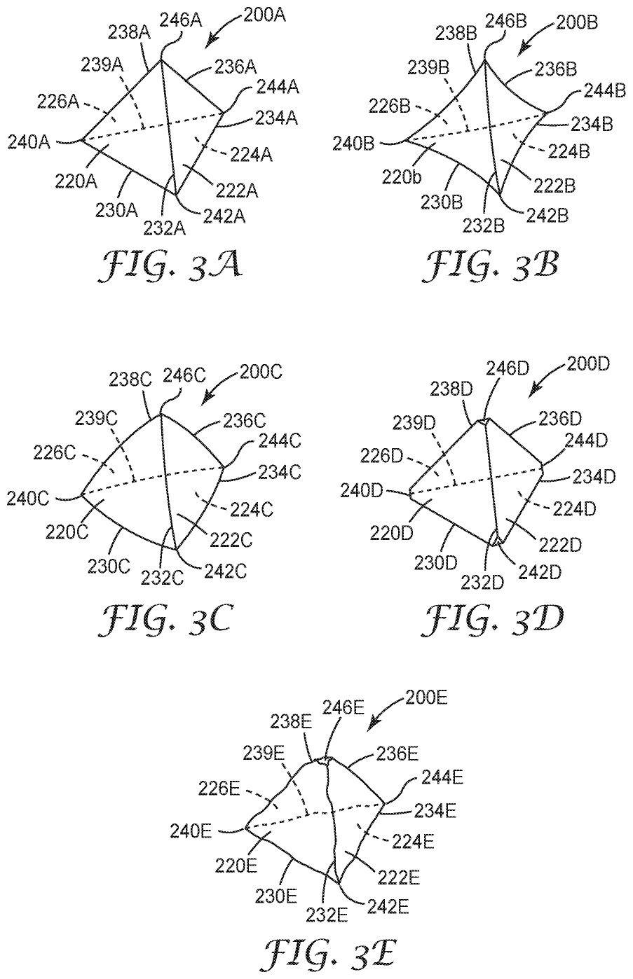

FIGS. 3A-3E are perspective views of examples of shaped abrasive particles 92 shaped that can be used in the methods described herein. The shaped abrasive particles can have any suitable shape, including the tetrahedral shape shown in FIGS. 3A-3E. As shown in FIGS. 3A-3E, shaped abrasive particles 92 are shaped as regular tetrahedrons. As shown in FIG. 3A, shaped abrasive particle 92 has four faces (320A, 322A, 324A, and 326A) joined by six edges (330A, 332A, 334A, 336A, 338A, and 339A) terminating at four vertices (340A, 342A, 344A, and 346A). Each of the faces contacts the other three of the faces at the edges. While a regular tetrahedron (e.g., having six equal edges and four faces) is depicted in FIG. 3A, it will be recognized that other shapes are also permissible. For example, tetrahedral abrasive particles 92 can be shaped as irregular tetrahedrons (e.g., having edges of differing lengths).

The shaped abrasive particles described herein can be magnetized or magnetizable but need not be either. Magnetized shaped abrasive particles can comprise at least one magnetic material can be included within or coat to shaped abrasive particle 92. Examples of magnetic materials include iron; cobalt; nickel; various alloys of nickel and iron marketed as Permalloy in various grades; various alloys of iron, nickel and cobalt marketed as Fernico, Kovar, FerNiCo I, or FerNiCo II; various alloys of iron, aluminum, nickel, cobalt, and sometimes also copper and/or titanium marketed as Alnico in various grades; alloys of iron, silicon, and aluminum (about 85:9:6 by weight) marketed as Sendust alloy; Heusler alloys (e.g., Cu₂MnSn); manganese bismuthide (also known as Bismanol); rare earth magnetizable materials such as gadolinium, dysprosium, holmium, europium oxide, alloys of neodymium, iron and boron (e.g., Nd₂Fe₁₄B), and alloys of samarium and cobalt (e.g., SmCo₅); MnSb; MnOFe₂O₃; Y₃Fe₅O₁₂; CrO₂; MnAs; ferrites such as ferrite, magnetite; zinc ferrite; nickel ferrite; cobalt ferrite, magnesium ferrite, barium ferrite, and strontium ferrite; yttrium iron garnet; and combinations of the foregoing. In some embodiments, the magnetizable material is an alloy containing 8 to 12 weight percent aluminum, 15 to 26 wt % nickel, 5 to 24 wt % cobalt, up to 6 wt % copper, up to 1% titanium, wherein the balance of material to add up to 100 wt % is iron. In some other embodiments, a magnetizable coating can be deposited on an abrasive particle 100 using a vapor deposition technique such as, for example, physical vapor deposition (PVD) including magnetron sputtering.

Including these magnetizable materials can allow shaped abrasive particles 92 to be responsive a magnetic field. Any of shaped abrasive particles 92 can include the same material or include different materials. Shaped abrasive particles 92 can be formed in many suitable manners for example, the shaped abrasive particles 92 can be made according to a multi-operation process. The process can be carried out using any material or precursor dispersion material. Briefly, for embodiments where shaped abrasive particles 92 are monolithic ceramic particles, the process can include the operations of making either a seeded or non-seeded precursor dispersion that can be converted into a corresponding (e.g., a boehmite sol-gel that can be converted to alpha alumina); filling one or more mold cavities having the desired outer shape of shaped abrasive particle 92 with a precursor dispersion; drying the precursor dispersion to form precursor shaped abrasive particle; removing the precursor shaped abrasive particle 92 from the mold cavities; calcining the precursor shaped abrasive particle 92 to form calcined, precursor shaped abrasive particle 92; and then sintering the calcined, precursor shaped abrasive particle 92 to form shaped abrasive particle 92. Any of the abrasive articles described herein can be continuous or can comprise abrasive segments.

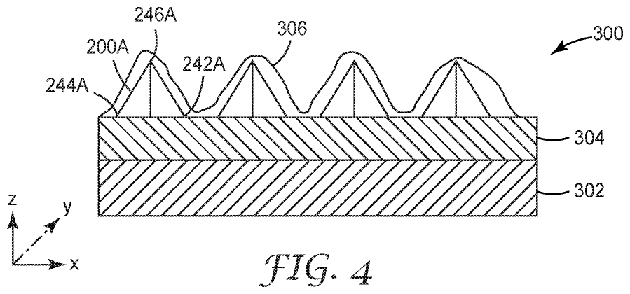

FIG. 4 is a sectional view of coated abrasive article 400. Coated abrasive article 400 includes backing 402 defining a surface along an x-y direction. Backing 402 has a first layer of binder, hereinafter referred to as make coat 404, applied over a first surface of backing 402. Attached or partially embedded in make coat 404 are a plurality of shaped abrasive particles 92.

Although shaped abrasive particles 92 are shown any other shaped abrasive particle described herein can be included in coated abrasive article 400. An optional second layer of binder, hereinafter referred to as size coat 400, is dispersed over shaped abrasive particles 92. As shown, a major portion of shaped abrasive particles 92 have at least one of three vertices (440, 442, and 444) oriented in substantially the same direction. Thus, shaped abrasive particles 400 are oriented according to a non-random distribution, although in other embodiments any of shaped abrasive particles 92 can be randomly oriented on backing 402. In some embodiments, control of a particle's orientation can increase the cut of the abrasive article.

Backing 402 can be flexible or rigid. Examples of suitable materials for forming a flexible backing include a polymeric film, a metal foil, a woven fabric, a knitted fabric, paper, vulcanized fiber, a staple fiber, a continuous fiber, a nonwoven, a foam, a screen, a laminate, and combinations thereof. Backing 402 can be shaped to allow coated abrasive article 400 to be in the form of sheets, discs, belts, pads, or rolls. In some embodiments, backing 402 can be sufficiently flexible to allow coated abrasive article 400 to be formed into a loop to make an abrasive belt that can be run on suitable grinding equipment.

Any of the abrasive articles described herein, including abrasive article 400, can also include conventional (e.g., crushed) abrasive particles. Examples of useful abrasive particles include fused aluminum oxide-based materials such as aluminum oxide, ceramic aluminum oxide (which can include one or more metal oxide modifiers and/or seeding or nucleating agents), and heat-treated aluminum oxide, silicon carbide, co-fused alumina-zirconia, diamond, ceria, titanium diboride, cubic boron nitride, boron carbide, garnet, flint, emery, sol-gel derived abrasive particles, and mixtures thereof.

The conventional abrasive particles can, for example, have an average diameter ranging from about 10 μm to about 2000 μm, about 20 μm to about 1300 μm, about 50 μm to about 1000 μm, less than, equal to, or greater than about 10 μm, 20, 30, 40, 50, 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1550, 1650, 1700, 1750, 1800, 1850, 1900, 1950, or 2000 μm. For example, the conventional abrasive particles can have an abrasives industry—specified nominal grade. Such abrasives industry—accepted grading standards include those known as the American National Standards Institute, Inc. (ANSI) standards, Federation of European Producers of Abrasive Products (FEPA) standards, and Japanese Industrial Standard (HS) standards. Exemplary ANSI grade designations (e.g., specified nominal grades) include: ANSI 12 (1842 μm), ANSI 16 (1320 μm), ANSI 20 (905 μm), ANSI 24 (728 μm), ANSI 36 (530 μm), ANSI 40 (420 μm), ANSI 50 (351 μm), ANSI 60 (264 μm), ANSI 80 (195 μm), ANSI 100 (141 μm), ANSI 120 (116 μm), ANSI 150 (93 μm), ANSI 180 (78 μm), ANSI 220 (66 μm), ANSI 240 (53 μm), ANSI 280 (44 μm), ANSI 320 (46 μm), ANSI 360 (30 μm), ANSI 400 (24 μm), and ANSI 600 (16 μm). Exemplary FEPA grade designations include P12 (1746 μm), P16 (1320 μm), P20 (984 μm), P24 (728 μm), P30 (630 μm), P36 (530 μm), P40 (420 μm), P50 (326 μm), P60 (264 μm), P80 (195 μm), P100 (156 um), P120 (127 μm), P120 (127 μm), P150 (97 μm), P180 (78 μm), P220 (66 μm), P240 (60 μm), P280 (53 μm), P320 (46 μm), P360 (41 μm), P400 (36 μm), P500 (30 μm), P600 (26 μm), and P800 (22 μm). An approximate average particles size of reach grade is listed in parenthesis following each grade designation.

Shaped abrasive particles 92 or crushed abrasive particles can include any suitable material or mixture of materials. For example, shaped abrasive particles 92 can include a material chosen from an alpha-alumina, a fused aluminum oxide, a heat-treated aluminum oxide, a ceramic aluminum oxide, a sintered aluminum oxide, a silicon carbide, a titanium diboride, a boron carbide, a tungsten carbide, a titanium carbide, a diamond, a cubic boron nitride, a garnet, a fused alumina-zirconia, a sol-gel derived abrasive particle, a cerium oxide, a zirconium oxide, a titanium oxide, and combinations thereof. In some embodiments, shaped abrasive particles 92 and crushed abrasive particles can include the same materials. In further embodiments, shaped abrasive particles 92 and crushed abrasive particles can include different materials.

Filler particles can also be included in abrasive articles 400. Examples of useful fillers include metal carbonates (such as calcium carbonate, calcium magnesium carbonate, sodium carbonate, magnesium carbonate), silica (such as quartz, glass beads, glass bubbles and glass fibers), silicates (such as talc, clays, montmorillonite, feldspar, mica, calcium silicate, calcium metasilicate, sodium aluminosilicate, sodium silicate), metal sulfates (such as calcium sulfate, barium sulfate, sodium sulfate, aluminum sodium sulfate, aluminum sulfate), gypsum, vermiculite, sugar, wood flour, a hydrated aluminum compound, carbon black, metal oxides (such as calcium oxide, aluminum oxide, tin oxide, titanium dioxide), metal sulfites (such as calcium sulfite), thermoplastic particles (such as polycarbonate, polyetherimide, polyester, polyethylene, poly(vinylchloride), polysulfone, polystyrene, acrylonitrile-butadiene-styrene block copolymer, polypropylene, acetal polymers, polyurethanes, nylon particles) and thermosetting particles (such as phenolic bubbles, phenolic beads, polyurethane foam particles and the like). The filler may also be a salt such as a halide salt. Examples of halide salts include sodium chloride, potassium cryolite, sodium cryolite, ammonium cryolite, potassium tetrafluoroborate, sodium tetrafluoroborate, silicon fluorides, potassium chloride, magnesium chloride. Examples of metal fillers include, tin, lead, bismuth, cobalt, antimony, cadmium, iron and titanium. Other miscellaneous fillers include sulfur, organic sulfur compounds, graphite, lithium stearate and metallic sulfides. In some embodiments, individual shaped abrasive particles 100 or individual crushed abrasive particles can be at least partially coated with an amorphous, ceramic, or organic coating. Examples of suitable components of the coatings include, a silane, glass, iron oxide, aluminum oxide, or combinations thereof. Coatings such as these can aid in processability and bonding of the particles to a resin of a binder.

The term “about” as used herein can allow for a degree of variability in a value or range, for example, within 10%, within 5%, or within 1% of a stated value or of a stated limit of a range.

Unless specified otherwise herein, the term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more. In some instances, “substantially” means entirely or 100%.

Unless specified otherwise herein, the term “substantially no” as used herein refers to a minority of, or mostly no, as in less than about 10%, 5%, 2%, 1%, 0.5%, 0.01%, 0.001%, or less than about 0.0001% or less.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise. In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Select embodiments of the present disclosure include, but are not limited to, the following:

In a first embodiment, the disclosure relates to a method of making a coated abrasive article, the method comprising sequentially:

locating a plurality of shaped abrasive particles in a tool comprising a plurality of cavities, wherein the plurality of shaped abrasive particles is held in the plurality of cavities, at least in part, electrostatically; and

disposing the plurality of shaped abrasive particles onto a make layer precursor of a backing having first and second opposed major surfaces, wherein the make layer precursor is disposed on at least a portion of the first major surface.

Embodiment 2 relates to the method of Embodiment 1, wherein the plurality of shaped abrasive particles is held in the plurality of cavities, at least in part, by vacuum.

Embodiment 3 relates to the method of Embodiment 1, wherein the plurality of shaped abrasive particles is held in the plurality of cavities substantially electrostatically.

Embodiment 4 relates to the method of Embodiment 1, wherein the tool is at least partially conductive and has a front and a back face, wherein the front face comprises the plurality of cavities and the back face is in close proximity to an electrically grounded member.

Embodiment 5 relates to the method of Embodiment 1, wherein the particles are released from the tool and disposed onto the make layer precursor by placing the tool over an insulating substrate separated by a gap from an electrically grounded member and applying a voltage drop across the gap to release the particles from the tool.

Embodiment 6 relates to the method of Embodiment 5, wherein the voltage drop is a voltage drop of at least about 9 kV.

Embodiment 7 relates to the method of any one of Embodiments 1 to 6, wherein at least a portion of the tool is conductive.

Embodiment 8 relates to the method of Embodiment 1, further comprising at least partially curing the make layer precursor to provide a make layer.

Embodiment 9 relates to the method of Embodiment 1, further comprising: disposing a size layer precursor over at least a portion of the make layer, shaped abrasive particles; and

at least partially curing the size layer precursor layer to provide a size layer.

Embodiment 10 relates to the method of Embodiment 9, further comprising applying a supersize layer over at least a portion of the size layer.

Embodiment 11 relates to the method of Embodiments 1-10, wherein the shaped abrasive particles have an average maximum particle dimension of less than or equal to of 25 to 3000 microns.

Embodiment 12 relates to the method of Embodiments 1-11, wherein the shaped abrasive particles have an average aspect ratio of at least 2:1.

Embodiment 13 relates to the method of Embodiments 1-12, wherein the shaped abrasive particles are not magnetized or magnetizable.

Embodiment 14 relates to the method of Embodiments 1-13, wherein the plurality of shaped abrasive particles are negatively charged and the tool is positively charged.

Embodiment 15 relates to the method of Embodiments 1-13, wherein the plurality of shaped abrasive particles are positively charged and the tool is negatively charged.

Embodiment 16 relates to a coated abrasive article made by the method Embodiments 1-14.

It will be apparent to those skilled in the art that the specific structures, features, details, configurations, etc., that are disclosed herein are simply examples that can be modified and/or combined in numerous embodiments. All such variations and combinations are contemplated by the inventor as being within the bounds of this disclosure. Thus, the scope of the disclosure should not be limited to the specific illustrative structures described herein, but rather extends at least to the structures described by the language of the claims, and the equivalents of those structures. To the extent that there is a conflict or discrepancy between this specification as written and the disclosure in any document incorporated by reference herein, this specification as written will control. Furthermore, all publications, patents, and patent documents referred to in this document are incorporated by reference herein in their entirety, as though they were fully set forth herein.

1. A method of making a coated abrasive article, the method comprising sequentially:
locating a plurality of shaped abrasive particles in a tool comprising a plurality of cavities at a filling section, wherein the plurality of shaped abrasive particles is held in the plurality of cavities, at least in part, electrostatically: wherein the production tool is travellng along a first web path;
electrostatically holding the plurality of shaped abrasive particles in the plurality of cavities while the production tool travels from the filling section to a backing, and
disposing the plurality of shaped abrasive particles onto a make layer precursor of the backing having first and second opposed major surfaces, wherein the make layer precursor is disposed on at least a portion of the first major surface.

2. The method of claim 1, wherein the plurality of shaped abrasive particles is held in the plurality of cavities, at least in part, by vacuum.

3. The method of claim 1, wherein the plurality of shaped abrasive particles is held in the plurality of cavities substantially electrostatically.

4. The method of claim 1, wherein the tool is at least partially conductive and has a front and a back face, wherein the front face comprises the plurality of cavities and the back face is in close proximity to an electrically grounded member.

5. The method of claim 1, wherein the particles are released from the tool and disposed onto the make layer precursor by placing the tool over an insulating substrate separated by a gap from an electrically grounded member and applying a voltage drop across the gap to release the particles from the tool.

6. The method of claim 5, wherein the voltage drop is a voltage drop of at least about 9 kV.

7. The method of claim 1, wherein at least a portion of the tool is conductive.

8. The method of claim 1, further comprising at least partially curing the make layer precursor to provide a make layer.

9. The method of claim 1, further comprising:
disposing a size layer precursor over at least a portion of the make layer, shaped abrasive particles; and
at least partially curing the size layer precursor layer to provide a size layer.

10. The method of claim 9, further comprising applying a supersize layer over at least a portion of the size layer.

11. The method of claim 1, wherein the shaped abrasive particles have an average maximum particle dimension of less than or equal to of 25 to 3000 microns.

12. The method of claim 1, wherein the shaped abrasive particles have an average aspect ratio of at least 2:1.

13. The method of claim 1, wherein the shaped abrasive particles are not magnetized or magnetizable.

14. The method of claim 1, wherein the plurality of shaped abrasive particles are negatively charged and the tool is positively charged.

15. The method of claim 1, wherein the plurality of shaped abrasive particles are positively charged and the tool is negatively charged.

16. A coated abrasive article made by the method of claim 1.
